(19) United States
(12) Patent Application Publication
(10) Pub. No.: US 2020/0358336 A1
(43) Pub. Date: Nov. 12, 2020

(54) ROTOR COOLING APPARATUS OF AN ELECTRIC VEHICLE POWERTRAIN COMPRISING INTEGRATED MOTOR, REDUCTION GEARBOX AND DIFFERENTIAL AND ROTOR COOLING METHOD OF THE SAME

(71) Applicant: An-Tao Anthony Yang, Burnaby (CA)

(72) Inventor: An-Tao Anthony Yang, Burnaby (CA)

(21) Appl. No.: 16/407,134

(22) Filed: May 8, 2019

(51) Int. Cl. H02K 7/116; B60K 17/12; H02K 9/19; F16H 3/72; F16H 57/04

(52) U.S. Cl. CPC H02K 7/116; B60K 17/12; F16H 2200/2007; F16H 3/72; F16H 57/0482; H02K 9/19

(57) ABSTRACT

Provided is a powertrain assembly including: an integrated motor, a first reduction gearbox, a second reduction gearbox, and a differential; wherein the integrated motor comprises a motor casing, a stator, a rotor, at least one cooling duct; wherein the first reduction gearbox comprises a first planetary gear, a second planetary gear, a third planetary gear, a first double-side ring gear, a first planetary carrier, and at least two oil seals; wherein the second reduction gearbox comprises a fourth planetary gear, a fifth planetary gear, a sixth planetary gear, a second double-side ring gear, a second planetary carrier, and at least two oil seal; wherein the differential comprises a cross tube, a first gear, a second gear, a third gear and a cross link shaft.

### BACKGROUND

During motor operation, heat is generated internally thus resulting an increase of internal temperature. In order to cooling the motor internals, coolant is injected into the motor to absorb the heat from the motor internals, and the coolant is then circulated out of the motor and cooled by a heat exchanger. However, there are risks associated with such cooling method; the life of the winding may be shortened due to the chemical properties of the coolant or debris within the coolant.

The commonly used drivetrain layout in the Electrical Vehicle (EV) having a motor attached to a reduction gearbox, and the reduction gearbox is then attached to a differential. Due to the installation clearance acting as an air gap between the motor shaft and the reduction gearbox, the gearbox has a limited cooling effect to the motor internals.

### FIELD OF INVENTION

The present invention provides a powertrain assembly design and its cooling method, in particular a powertrain for electric vehicle having an integrated motor, reduction gearbox and differential.

### PROBLEMS TO BE SOLVED

The primary objective is to provide a powertrain assembly design and its cooling method, in particular for an EV powertrain having an integrated motor, a first reduction gearbox, a second reduction gearbox and a differential. The integrated motor includes a rotor. One end of the rotor is submerged in a lubricant inside the first reduction gearbox and the other end of the rotor is submerged in a lubricant inside the second reduction gearbox to cool down the rotor. The lubricant then transfers heat to the first reduction gearbox and the second reduction gearbox. The first reduction gearbox and the second reduction gearbox then transfer the heat to a motor casing.

It is also an objective to provide a powertrain assembly design and its cooling method for an EV powertrain comprising a motor casing, a stator, a rotor, a liquid cooling duct, a reduction gearbox, planetary gears, planetary carriers, double-side ring gears, gears, a driveshaft and shaft seals.

### SUMMARY OF INVENTION

Provided is a powertrain assembly comprising: an integrated motor, a first reduction gearbox, a second reduction gearbox, and a differential,

wherein the integrated motor comprises a motor casing, a stator, a rotor, and at least one cooling duct,

wherein the first reduction gearbox comprises a first planetary gear, a second planetary gear, a third planetary gear, a first double-side ring gear, a first planetary carrier, a first oil seal, and a second oil seal,

wherein the second reduction gearbox comprises a fourth planetary gear, a fifth planetary gear, a sixth planetary gear, a second double-side ring gear, a second planetary carrier, a third oil seal, and a fourth oil seal,

wherein the differential comprises a cross tube, a first gear, a second gear, a third gear, and a cross link shaft,

wherein said first reduction gearbox is attached to said motor casing,

wherein said motor casing is attached to said second reduction gearbox,

wherein said first reduction gearbox is attached to said cross tube,

wherein said cross tube is attached to said second reduction gearbox,

wherein said first oil seal is attached to said first reduction gearbox,

wherein said first planetary carrier is rotatably attached to said first oil seal,

wherein said first planetary gear, said second planetary gear and said third planetary gear are rotatably attached to said first planetary carrier and are meshing with said rotor and said first double-side ring gear,

wherein said rotor is rotatably attached to said second oil seal,

wherein said second oil seal is attached to said first reduction gearbox,

wherein said first double-side ring gear is meshing with said first gear,

wherein said first gear is attached to said cross link shaft,

wherein said cross link shaft is attached to said second gear,

wherein said second gear is meshing with said third gear,

wherein said third gear is meshing with said second double-side ring gear,

wherein said fourth oil seal is attached to said second reduction gearbox,

wherein said second planetary carrier is rotatably attached to said fourth oil seal,

wherein said fourth planetary gear, said fifth planetary gear and said sixth planetary gear are rotatably attached to said second planetary carrier and are meshing with said rotor and said second double-side ring gear,

wherein said rotor is rotatably attached to said third oil seal,

wherein said third oil seal is attached to said second reduction gearbox,

wherein each of said first reduction gearbox and said second reduction gearbox contains lubricant,

wherein said second oil seal and said third oil seal prevent said lubricant from entering said motor casing,

wherein said first oil seal and said second oil seal prevent leakage of said lubricant from said first reduction gearbox and said second reduction gearbox, respectively,

wherein both ends of said rotor are submerged in said lubricant.

Provides is also a method of cooling the powertrain assembly, includes: conducting the heat generated inside said rotor to both ends of said rotor; transferring the heat from said rotor to said lubricant through a direct contact; transferring the heat from said lubricant to the casing of said first reduction gearbox and said second reduction gearbox through a direct contact; conducting the heat from said first reduction gearbox and said second reduction gearbox to said motor casing; and

injecting a coolant into the cooling duct located inside the motor casing to dissipate the heat.

### ADVANTAGES OF INVENTION

According to the present invention, a motor rotor inside a powertrain assembly can be efficiently cooled down.

### DESCRIPTION OF THE DRAWINGS

FIG. 1 is perspective view of an electric vehicle powertrain according to a first embodiment of the present invention.

FIG. 2 is an exploded view of the electric vehicle powertrain according to the first embodiment of the present invention.

FIG. 3 is a sectional view of the electric vehicle powertrain according to the first embodiment of the present invention.

### DESCRIPTION

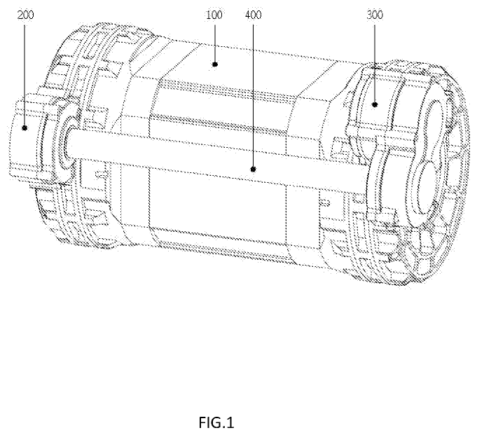

Referring to FIG. 1, an electric vehicle powertrain according to a first embodiment comprises a motor casing 100, a first reduction gearbox 200, a second reduction gearbox 300, a cross tube 400; wherein the motor casing 100 is attached to the first reduction gearbox 200, the first reduction gearbox 200 is attached to the cross tube 400, the cross tube 400 is attached to the second gearbox 300, and the second reduction gearbox 300 is attached to the motor casing 100.

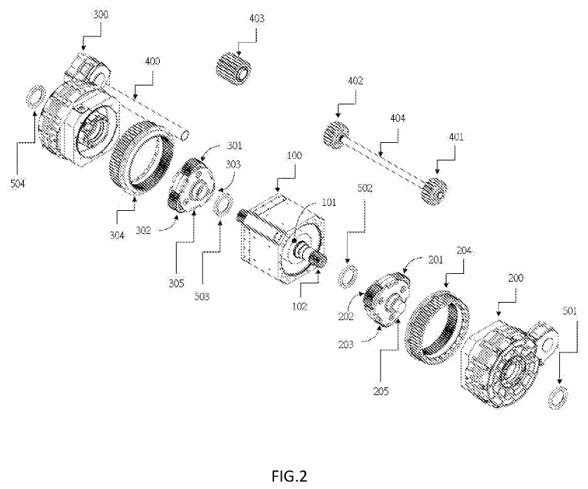

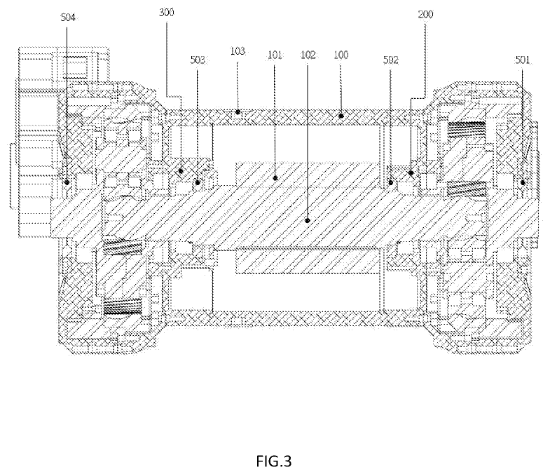

Referring to FIG. 2 and FIG. 3, the first embodiment comprises the motor casing 100, a stator 101, a rotor 102, a cooling duct 103, a first reduction gearbox 200, a first planetary gear 201, a second planetary gear 202, a third planetary gear 203, a first double-side ring gear 204, a first planetary carrier 205, a second reduction gearbox 300, a fourth planetary gear 301, a fifth planetary gear 302, a sixth planetary gear 303, a second double-side ring gear 304, a second planetary carrier 305, a cross tube 400, a first gear 401, a second gear 402, a third gear 403, a cross link shaft 404, a first oil seal 501, a second oil seal 502, a third oil seal 503 and a fourth oil seal 504. There are gears machined on both ends of the rotor 102, respectively. There are gears machined on both of an outside surface and an inside surface of the first double-side ring gear 204 and the second double-side ring gear 304.

The first oil seal 501 is attached to the first reduction gearbox 200, the first planetary carrier 205 is rotatably attached to the first oil seal 501, the first planetary gear 201, the second planetary gear 202 and the third planetary gear 203 are rotatably attached to the first planetary carrier 205 and are meshing with the gears at the end of the rotor 102 and with gears on the inside surface of the first double-side ring gear 204, the rotor 102 is also rotatably attached to the second oil seal 502, and the second oil seal 502 is attached to the first reduction gearbox 200.

The fourth oil seal 504 is attached to the second reduction gearbox 300, the second planetary carrier 305 is rotatably attached to the fourth oil seal 504, the fourth planetary gear 301, the fifth planetary gear 302 and the sixth planetary gear 303 are rotatably attached to the second planetary carrier 305 and are meshing with the gears at the end of the rotor 102 and with the gears on the inside surface of the second double-side ring gear 304, the rotor 102 is also rotatably attached to the third oil seal 503, and the third oil seal 503 is attached to the second reduction gearbox 300.

The gears on the outside surface of the first double-side ring gear 204 are meshed with the first gear 401, the first gar 401 is attached to the cross link shaft 404, the cross link shaft 404 is attached to the second gear 402, the second gear 402 is meshed with the third gear 403, and the third gear 403 is meshed with the gears on the outside surface of the second double-side ring gear 304.

The first reduction gearbox 200 and the second reduction gearbox 300 contains lubricant, and the first oil seal 501, the second oil seal 502, the third oil seal 503 and the fourth oil seal 504 are utilized to prevent leakage of such lubricant into the motor casing 100 or out of the first reduction gearbox 200 or the second reduction gearbox 300.

During operation of the motor, heat is generated in the rotor 102 and the stator 101. The heat generated in the rotor 102 is conducted to the both ends of the rotor 102 and transferred into the lubricant inside the first reduction gearbox 200 and the second reduction gearbox 300. Heat is then transferred from the lubricant into the case of the first reduction gearbox 200 and the second reduction gearbox 300 through direct contact, and then transferred from the case of the first reduction gearbox 200 and the second reduction gearbox 300 into the motor casing 100, coolant is then injected into the cooling duct 103 to remove the heat from the motor casing 100.

1. A powertrain assembly comprising:
an integrated motor, a first reduction gearbox, a second reduction gearbox, and a differential,
wherein the integrated motor comprises a motor casing, a stator, a rotor, and at least one cooling duct,
wherein the first reduction gearbox comprises a first planetary gear, a second planetary gear, a third planetary gear, a first double-side ring gear, a first planetary carrier, a first oil seal, and a second oil seal,
wherein the second reduction gearbox comprises a fourth planetary gear, a fifth planetary gear, a sixth planetary gear, a second double-side ring gear, a second planetary carrier, a third oil seal, and a fourth oil seal,
wherein the differential comprises a cross tube, a first gear, a second gear, a third gear, and a cross link shaft,
wherein said first reduction gearbox is attached to said motor casing,
wherein said motor casing is attached to said second reduction gearbox,
wherein said first reduction gearbox is attached to said cross tube,
wherein said cross tube is attached to said reduction second gearbox,
wherein said first oil seal is attached to said first reduction gearbox,
wherein said first planetary carrier is rotatably attached to said first oil seal,
wherein said first planetary gear, said second planetary gear and said third planetary gear are rotatably attached to said first planetary carrier and are meshing with said rotor and said first double-side ring gear,
wherein said rotor is rotatably attached to said second oil seal,
wherein said second oil seal is attached to said first reduction gearbox,
wherein said first double-side ring gear is meshing with said first gear,
wherein said first gear is attached to said cross link shaft,
wherein said cross link shaft is attached to said second gear,
wherein said second gear is meshing with said third gear,
wherein said third gear is meshing with said second double-side ring gear,
wherein said fourth oil seal is attached to said second reduction gearbox,
wherein said second planetary carrier is rotatably attached to said fourth oil seal,
wherein said fourth planetary gear, said fifth planetary gear and said sixth planetary gear are rotatably attached to said second planetary carrier and are meshing with said rotor and said second double-side ring gear,
wherein said rotor is rotatably attached to said third oil seal,
wherein said third oil seal is attached to said second reduction gearbox,
wherein each of said first reduction gearbox and said second reduction gearbox contains lubricant,
wherein said second oil seal and said third oil seal prevent said lubricant from entering said motor casing,
wherein said first oil seal and said second oil seal prevent leakage of said lubricant from said first reduction gearbox and said second reduction gearbox, respectively,
wherein both ends of said rotor are submerged in said lubricant.

2. A method of cooling a powertrain assembly,
wherein the powertrain assembly includes an integrated motor, a reduction gearbox, and a differential,
wherein the integrated motor comprises a motor casing, a stator, a rotor, and at least one cooling duct,
wherein the first reduction gearbox comprises a first planetary gear, a second planetary gear, a third planetary gear, a first double-side ring gear, a first planetary carrier, a first oil seal, and a second oil seal,
wherein the second reduction gearbox comprises a fourth planetary gear, a fifth planetary gear, a sixth planetary gear, a second double-side ring gear, a second planetary carrier, a third oil seal, and a fourth oil seal,
wherein the differential comprises a cross tube, a first gear, a second gear, a third gear, and a cross link shaft,
wherein said first reduction gearbox is attached to said motor casing,
wherein said motor casing is attached to said second reduction gearbox,
wherein said first reduction gearbox is attached to said cross tube,
wherein said cross tube is attached to said reduction second gearbox,
wherein said first oil seal is attached to said first reduction gearbox,
wherein said first planetary carrier is rotatably attached to said first oil seal,
wherein said first planetary gear, said second planetary gear and said third planetary gear are rotatably attached to said first planetary carrier and are meshing with said rotor and said first double-side ring gear,
wherein said rotor is rotatably attached to said second oil seal,
wherein said second oil seal is attached to said first reduction gearbox,
wherein said first double-side ring gear is meshing with said first gear,
wherein said first gear is attached to said cross link shaft,
wherein said cross link shaft is attached to said second gear,
wherein said second gear is meshing with said third gear,
wherein said third gear is meshing with said second double-side ring gear,
wherein said fourth oil seal is attached to said second reduction gearbox,
wherein said second planetary carrier is rotatably attached to said fourth oil seal,
wherein said fourth planetary gear, said fifth planetary gear and said sixth planetary gear are rotatably attached to said second planetary carrier and are meshing with said rotor and said second double-side ring gear,
wherein said rotor is rotatably attached to said third oil seal,
wherein said third oil seal is attached to said second reduction gearbox,
wherein each of said first reduction gearbox and said second reduction gearbox contains lubricant,
wherein said second oil seal and said third oil seal prevent said lubricant from entering said motor casing,
wherein said first oil seal and said second oil seal prevent leakage of said lubricant from said first reduction gearbox and said second reduction gearbox, respectively,
wherein both ends of said rotor are submerged in said lubricant,
wherein the method includes:
conducting heat generated inside said rotor to both ends of said rotor;
transferring the heat from said rotor to said lubricant through a direct contact;
transferring the heat from said lubricant to the casing of said first reduction gearbox and said second reduction gearbox through a direct contact;
conducting the heat from said first reduction gearbox and said second reduction gearbox to said motor casing; and
injecting a coolant into the cooling duct located inside the motor casing to dissipate the heat.
